(19) United States
(12) Patent Application Publication
(10) Pub. No.: US 2007/0071374 A1
(43) Pub. Date: Mar. 29, 2007

(54) Motor oil leakage protection structure

(75) Inventors: Alex Hong, Kaohsiung City (TW); Show Fen Chen, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/272,676

(22) Filed: Nov. 15, 2005

(30) Foreign Application Priority Data
Sep. 26, 2005 (TW) 094133347

(51) Int. Cl. F16C 32/06

(52) U.S. Cl. 384/100

(57) ABSTRACT

The invention relates to a motor oil leakage protection structure, which includes a shaft tube. The inner wall of the shaft tube is formed at least two cascaded holes with different inner diameters. The hole with smaller inner diameter is disposed a bearing, and the hole with larger inner diameter is disposed a locating ring. Furthermore, the locating ring can isolate the top edge of the gap between the hole with smaller inner diameter and the bearing, and therefore, when the lubricating oil flows along the oil path formed by the gap and keeps rising up, due to the obstruction posed on the oil path, the rising speed of the lubricating oil is lessened so that the lubricating oil can be further absorbed and utilized repeatedly by the bearing to effectively avoid the drainage of the lubricating oil.

### FIELD OF THE INVENTION

The invention relates to a motor oil leakage protection structure, which is designed to protect lubricating oil from leaking and draining against the attrition of the spindle and the bearing of the motor, making the motor more durable.

### BACKGROUND OF THE INVENTION

When the spindle is rotating with respect to the bearing, lubricating oil is the lubricating medium to reduce the attrition therebetween. Therefore, how to protect lubricating oil from leaking is the major subject for settling attrition.

As shown in FIG. 1, the motor structure includes a motor 10 and a stator 20, wherein the rotor 10 has a spindle 11, a shaft tube 30 is sleeved by the stator 20, the shaft tube 30 contains a bearing 40 therein, the bearing 40 is clamped at a predetermined position between a locating ring 50 and a cap 60, and a snap ring 12 is clamped between the cap 60 and the bearing 40. Therefore, the spindle 11 of the rotor 10 penetrates through the bearing 40, rotates therein and is fixed by the snap ring 12 to prevent the rotor 10 from falling off. Practically, the leakage and drainage of the lubricating oil are critical to the life cycle of motor. After the lubricating oil inside the cap 60 is churned by the spindle 11, the lubricating oil will keep seeping out upwardly from the gap between the bearing 40 and the inner wall of the shaft tube 30 throughout the circulation process of the lubricating oil.

Consequently, the invention targets at the leakage issue of the lubricating oil between the bearing 40 and the inner wall of the shaft tube for sake of further development and enhancement.

Together with the reference to FIG. 2, the inner wall of the conventional motor shaft tube 30 takes the shape of a single-hole penetration pattern. According, after the lubricating oil within an oil storage room 61 is churned by the spindle 11, the lubricating oil keeps rising up along the inner wall of the shaft and the gap between the inner wall of the shaft tube 30 and the bearing 40a and swiftly seeps out from the gap between the inner wall of the shaft tube 30 and the locating ring 40, resulting in the drainage of the lubricating oil.

As such, for sake of preventing the attrition between the spindle 11 and the bearing 40 intended to prolong the life cycle of the motor, it is essential to solve the leakage issue of the aforementioned lubricating oil.

### SUMMARY OF THE INVENTION

In view of the above, the present invention brings up a motor oil leakage protection structure including a rotor having a spindle, a stator sheathed on a shaft tube, wherein at least two cascaded holes with different inner diameters are formed on the inner wall of the shaft tube, the hole with smaller inner diameter is disposed a bearing while the hole with larger inner diameter is disposed a locating ring, and the locating ring isolates the top edge of the gap between the hole with smaller inner diameter and the bearing to obstruct the oil path that the lubricating oil keeps rising up.

Therefore, when the lubricating oil keeps rising up along the gap between the hole with smaller inner diameter of the shaft tube and the bearing, the blockage posed on the oil path slows down the rising speed of the lubricating oil so that the lubricating oil is further absorbed and utilized by the bearing during circulation to effectively prevent the lubricating oil from draining.

### BRIEF DESCRIPTION OF THE DRAWINGS

FIG. 1 is a cross-sectional schematic view showing the entire conventional motor structure;

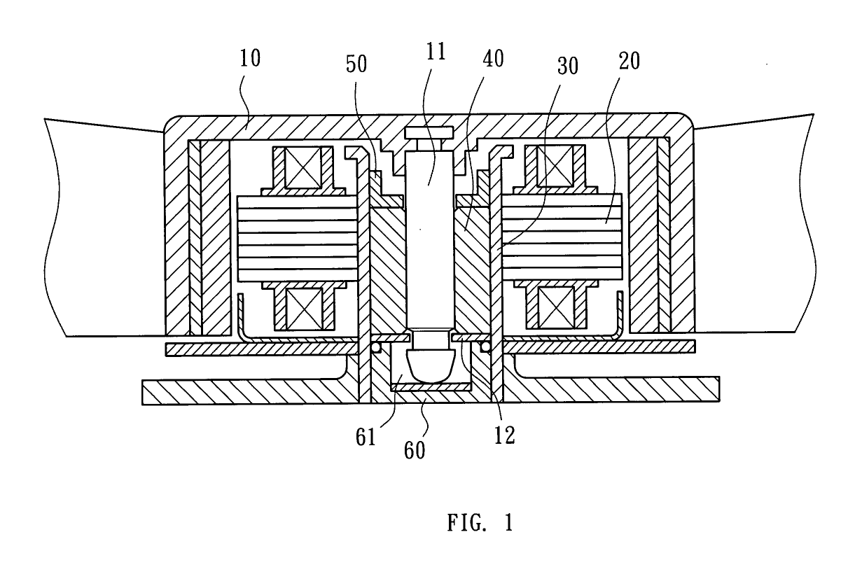

FIG. 2 is an enlarged partial schematic view showing the conventional motor structure;

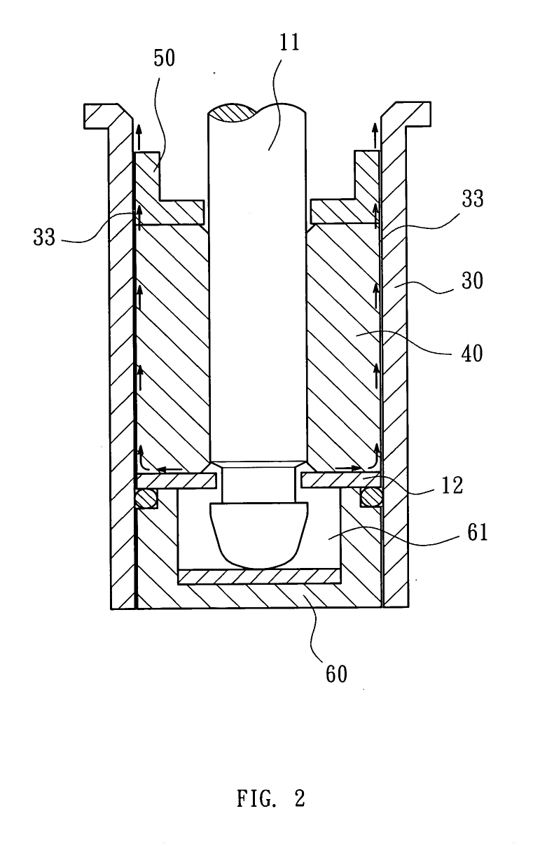

FIG. 3 is a cross-sectional schematic view showing the first preferred embodiment;

FIG. 4 is an enlarged partial schematic view of the first preferred embodiment; and

FIG. 5 is a cross-sectional schematic view of the second preferred embodiment.

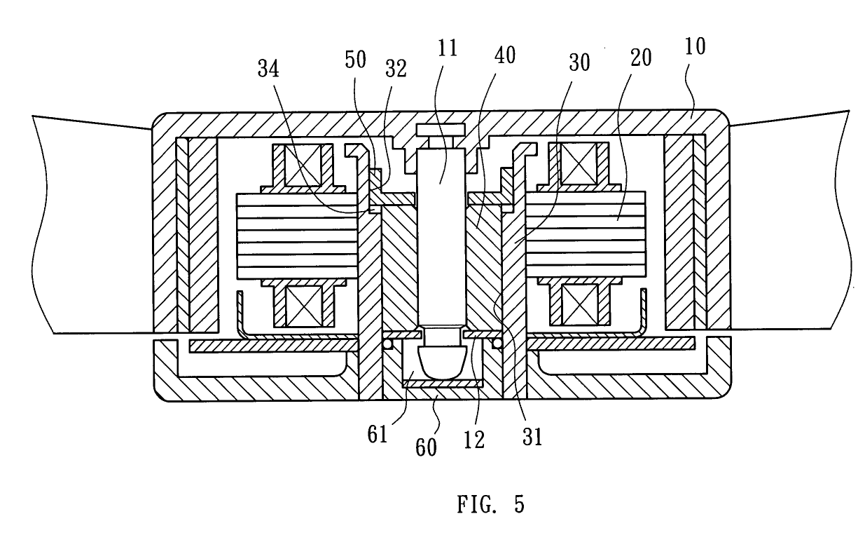

### DETAILED DESCRIPTION OF THE PREFERRED EMBODIMENT

The invention relates to a motor oil leakage protection structure, which at least two cascaded holes with different inner diameters are formed on the inner wall of the shaft tube, and a bearing and a locating ring are disposed in these holes with different inner diameters so that the locating ring blocks the oil path that the lubricating oil rises up to prevent the lubricating oil from draining.

Take few preferred embodiments as examples illustrative of the relevant position of respective part in the present invention;

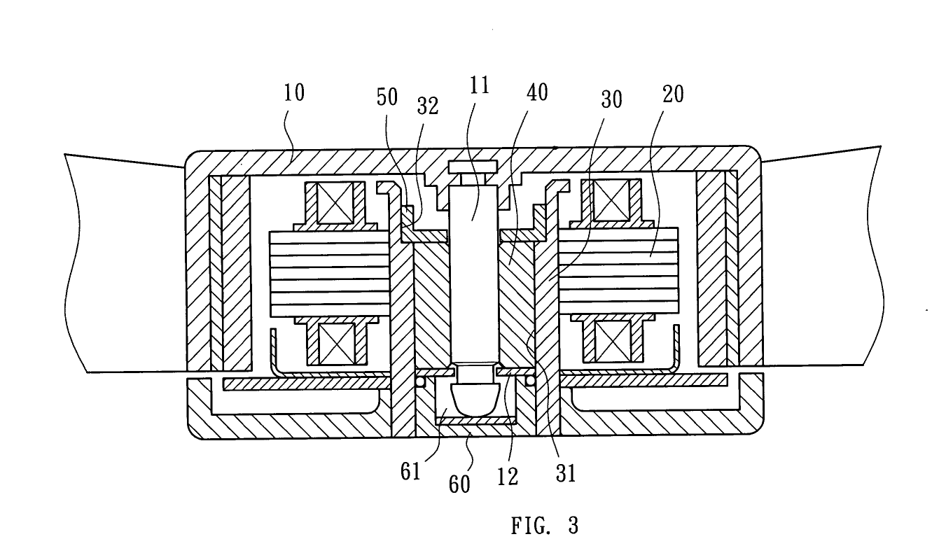

Please refer to FIG. 3. The motor structure includes a rotor 10 having a spindle 11, a stator 20 disposed on a shaft tube 30, wherein the shaft tube 30 is orderly disposed a locating ring 50, a bearing 40, a snap ring 12 and a cap 60, the inner wall of the shaft tube 30 is formed at least two cascaded holes with different inner diameters where the bearing 40, the snap ring 12 and the cap 60 are located in the hole with smaller inner diameter 31 and the locating ring 50 is located in the hole with larger inner diameter, and the locating ring 50 exactly isolates the top edge of the gap between the hole with smaller inner diameter 31 and the bearing 40 to obstruct the oil path that the lubricating oil keeps rising up and to prevent the lubricating oil from draining.

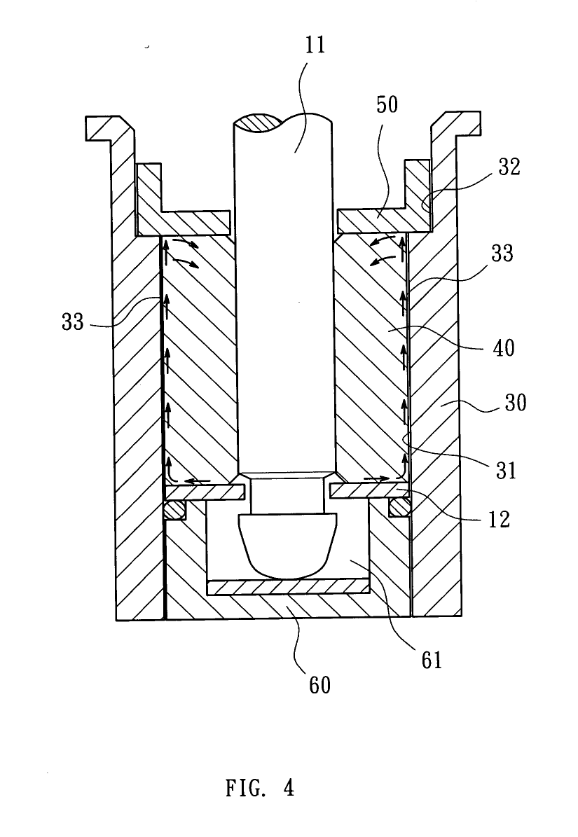

Together with the reference to FIG. 4, when the lubricating oil inside the oil containing room 61 of the cap 60 is churned by the spindle 11, the lubricating oil flows through the gap between the hole of the shaft tube 30 with smaller inner diameter 31 and the bearing 40 and keeps rising up. When rising to the top edge of the gap, as a result of the obstruction to the oil path, the locating ring 50 blocks and lessens the rising speed of the lubricating oil so that the lubricating oil can be further absorbed and utilized repeatedly by the bearing 40 and the drainage of the lubricating oil can be effectively avoided.

In addition, the invention can be one of the following preferred embodiments;

As shown in FIG. 4, the inner wall of the of the shaft tube 30 is formed two cascaded holes with different inner diameters, where the bearing 40, the snap ring 12 and the cap 60 are all located in the hole with smaller inner diameter 31 of the shaft tube 30, and the locating ring 50 is located in the hole with larger inner diameter 32 of the shaft tube 30. The top side of the bearing 40 is higher than the place where two cascaded holes neighbor each other, so as to form another oil containing room 34 between the bearing 40 and the locating ring 50.

Thus, when the lubricating oil flows through the gap between the hole with smaller inner hole of the shaft tube 30 and the bearing and keeps rising up, the locating ring 50 can also function to block the oil path 33 where the lubricating oil keeps rising up. Meanwhile, the oil containing room 34 can simply provide the guiding function for the blocked and bufferized lubricating oil and guide the lubricating oil to backflow for being repeatedly absorbed and utilized by the bearing 40.

By means of the above-mentioned design, the present invention not only blocks and lessens the rising speed of the lubricating oil, but also provides the flow guiding function for the lubricating oil so as to guide the backflow of the lubricating oil for repeated absorption and utilization by the bearing, effectively preventing the lubricating oil from draining, getting rid off the attrition between the spindle and the bearing and prolonging the life cycle of the motor. Therefore, the present invention not only has a novelty and a progressiveness, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A motor oil leakage protection structure, comprising:
a shaft tube;
wherein no less than two cascaded holes with two different inner diameters are formed on an inner wall of said shaft tube, said hole with a smaller inner diameter is disposed a bearing, said hole with a larger inner diameter is disposed a locating ring, said locating ring isolates a top edge of a gap between said hole with said smaller diameter and said bearing so as to block and lessen a rising oil speed in a oil path.

2. The motor oil leakage protection structure of claim 1, wherein a top side of said bearing is higher than a neighboring place of said cascaded holes with said inner diameters so as to form an oil containing room surrounded by said neighboring place, said bearing and said locating ring.
